(19) United States
(12) Patent Application Publication
(10) Pub. No.: US 2010/0288018 A1
(43) Pub. Date: Nov. 18, 2010

(54) FUEL SYSTEM FOR A COMBUSTION ENGINE HAVING LOCAL LEAKAGE DETECTION

(76) Inventor: Ulrich Hopmann, (US)

Correspondence Address: CATERPILLAR c/o LIELL, MCNEIL & HARPER;Intellectual Property Department, AH9510, 100 N.E. Adams, Peoria, IL, 61629-9510, US

(21) Appl. No.: 12/666,480

(22) PCT Filed: Jul. 4, 2008
(86) PCT No.: PCT/EP08/05495

§ 371 Date: Apr. 19, 2010

(30) Foreign Application Priority Data
Jul. 4, 2007 (EP) 07013107.3

(51) Int. Cl. G01M 3/28; F16L 55/00; F16L 39/00; F02M 55/02; G01M 15/00

(52) U.S. Cl. 73/40.5 R; 285/13; 73/114.42

(57) ABSTRACT

The application relates to a connector (11) for connecting at least a portion of a double-wall tubing (9) to a high-pressure line (4) and a fuel system having a high pressure line (4), a double wall tubing (9) and connector for coupling the double-wall tubing (9) to the high-pressure line (4). The connector (11) is configured to establish a fluid connection between a portion of the double wall tubing (9) and the high pressure line (4). The connector also provides a fluid detection passage, and a fluid connection between another portion of double wall tubing and said fluid detection passage. The application also relates to a method for detecting a leakage in a fuel system of the above type, having a plurality of first detection units and a second detection unit, in which fuel leakage, which may stem from different areas of the fuel system, may be detected by at least one of said first and second detection units.

### TECHNICAL FIELD

The present application relates to a connector for connecting double-wall tubing to a high-pressure line and in particular to a fuel system having a connector for connecting a double-wall tubing to a high-pressure line. The application also relates to a method for detecting a leakage in a fuel system.

### BACKGROUND

In engine technology it is known to supply fuel, which is under high pressure, via respective high pressure lines, which are also called common rails, to a plurality of injectors connected thereto. Common rail technology is in particular used in connection with diesel-fuel, but it may also be used with other fuels. If there is a defect in a line element which guides the high-pressure fuel or in the connecting areas thereof, this may lead to a fuel leakage.

Therefore, the high-pressure lines of the fuel system are commonly provided with sheathing system. In particular, an inner pressure line, which typically guides the fuel under high pressure, is surrounded by the sheathing system. Several different sheathing systems are possible, which irrespective of their specific design of the sheathing will be called “jacket tube” in the following description. Within the sheathing system leaking fuel may be lead away from the engine in a controlled manner. At the end of the sheathing system it is known to provide a leakage detecting unit, as it is for example known from U.S. Pat. No. 2,783,842 A. This allows a general and automatic leakage detection. The known leakage detection does not allow a local leakage detection, which would, however, be useful in order to take different measures in accordance with the location of the leakage.

The current disclosure is aimed at one or more of the disadvantages of the prior art.

### SUMMARY OF THE APPLICATION

In accordance with the present disclosure, a connector for connecting a double-wall tubing to a high-pressure line is provided, wherein the connector comprises a main body having a receiving opening for at least partially receiving the high-pressure line, a first passage which is open to the receiving opening for connecting at least a portion of the double-wall tubing to the high-pressure line, and a second passage which is open to the receiving opening. Means for detecting a fluid in the second passage are provided.

In accordance with the present disclosure, also a connector for connecting at least a portion of a double-wall tubing having an inner and outer tube to a high-pressure line is provided. The connector has a main body defining a connecting opening for establishing a fluid connection between the inner tube and the high-pressure line, a fluid detection passage and a fluid connection between the outer tube and the fluid detection passage.

In accordance with the present disclosure, also a fuel system for an engine is provided, the fuel system having a high pressure line, having a coupling opening, a double-wall tubing having an inner tube and an outer tube, a connector coupling said inner tube of the double-wall tubing to the coupling opening of the high-pressure line and providing a fluid connection between the outer tube of the double-wall tubing and a fluid detection passage of the connector. Means for detecting fluid in the fluid detecting passage and provided.

In accordance with the present disclosure, a method for detecting a leakage in a fuel system is provided, wherein said fuel system has a high-pressure line having a plurality of first sections, each surrounded by a respective jacket tube and a plurality of second sections each surrounded by a respective connector, said second sections having a coupling opening, and a plurality of a double-wall tubings each having an inner tube, and an outer tube. The respective elements are arranged such that a plurality of first spaces is formed between the respective jacket tubes and the high-pressure line and a plurality of second spaces is formed between the respective connectors and the high-pressure line, wherein the first and second spaces are sealed from each other, and wherein the outer tubes are fluidly connected to the second spaces. The method entails conducting leakage fluid from at least one of the second spaces to an associated one of a plurality of first fluid detections units and subsequently to a second fluid detection unit, conducting leakage fluid from the first space to a second fluid detection unit and detecting the presence of leakage fluid at at least one of the first and second detection units.

### BRIEF DESCRIPTION OF THE DRAWINGS

FIG. 1 is a schematic view of a fuel system in accordance with a first example;

FIG. 2 is a schematic view of a connector section of the fuel system according to FIG. 1;

FIG. 3 is a schematic cross-sectional view through a connector section according to FIG. 2;

FIG. 4 is an enlarged schematic view of a connector section as shown in FIG. 2, wherein parts of the connector are not shown to simplify the drawing;

FIG. 5 is a schematic sectional view similar to FIG. 3 of the connector section of FIG. 4;

FIG. 6 is a schematic sectional view of the connector section along line VI-VI in FIG. 5;

FIG. 7 is a schematic sectional view of the connector section along line VII-VII in FIG. 5;

FIG. 8 is a schematic view of an alternative connector section, wherein similar to FIG. 4 parts thereof are not shown to simplify the drawing;

FIG. 9 is a sectional view of the alternative connector section of FIG. 8, similar to the view of FIG. 6;

FIG. 10 is a sectional view of the connector section along line X-X in FIG. 9;

FIG. 11 is a schematic view of a further alternative connector section, wherein parts are not shown for simplifying the drawing;

FIG. 12 is a schematic sectional view of the connector section of FIG. 11, similar to the view of FIG. 6;

FIG. 13 is a schematic sectional view of the connector section along the line XIII-XIII in FIG. 12;

FIG. 14 is a schematic view of an alternative fuel system.

### DETAILED DESCRIPTION

In the following description, terms relating to locations and directions primarily refer to the views in the drawing, but they may also refer to a preferred final arrangement of the elements.

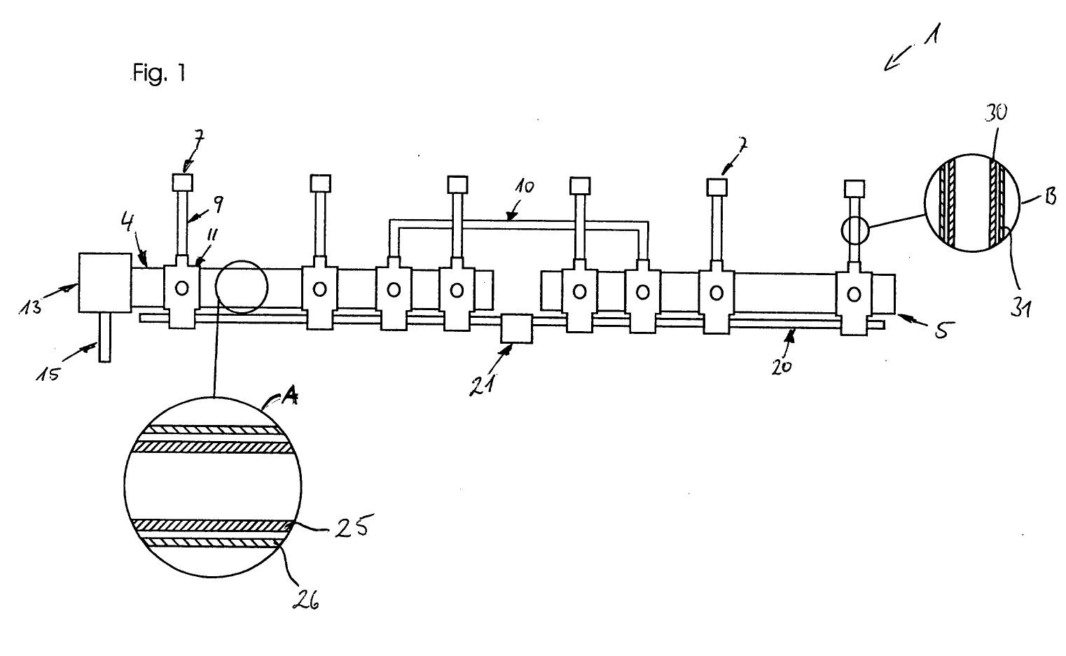

FIG. 1 shows a schematic view of one example of a fuel system 1 for a combustion engine (not shown). The fuel system 1 has two high-pressure lines 4, 5, which are typically referred to as common rails.

Furthermore, the fuel system 1 has a plurality of injector units 7, each connected via a connecting line 9 and a connector 11 to the high-pressure lines 4 and 5, respectively. The high-pressure lines 4, 5 are fluidly connected to each other via a connecting line 10 and respective connectors 11. The fuel system 1 further has another connector 13 connected to the high-pressure line 4. The connector 13 is connected to a source of high-pressure fuel (not shown), such as a fuel pump, via at least one connecting line 15.

The fuel system further has a leakage conduit 20 for receiving leaking fuel and a leakage fluid collecting container 21, which is fluidly connected to the leakage conduit 20. A sensor (not shown) is provided in the leakage fluid collecting container 21, for detecting a fluid, such as fuel, in the leakage fluid collecting containers and for issuing a corresponding signal. The leakage container may be located remotely away from the engine.

The high-pressure lines 4, 5 may each have a double-wall structure. In particular, the high-pressure lines 4, 5 may each have a continuous high-pressure tube, sections of which are surrounded by corresponding jacket tubes 26. The jacket tubes 26 surround the continuous high-pressure tube 25 in the sections which are adjacent to the connectors 11 and the connector 13, respectively. An enlarged sectional view of this double-wall structure is shown in the circle A in FIG. 1.

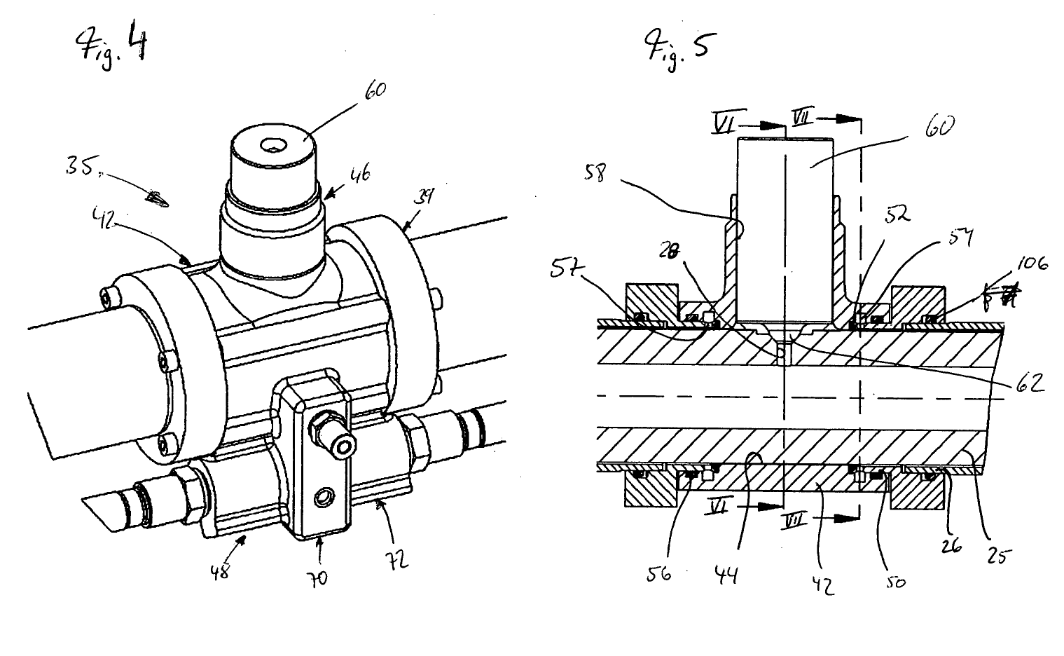

In the area of the connector 11 the high-pressure tube 25 is surrounded by the respective connectors 11, in order to also provide a double-wall structure in this area as will be explained in more detail herein below. Furthermore, the high-pressure tube 25 has a connecting bore in the area of each connector 11 (FIGS. 5 and 6).

The injection units 7 are shown only schematically in FIG. 1. They may be of any suitable type operating with a high-pressure fuel. In FIG. 1, six injection units 7 are provided, but naturally a different number of injections unit 7 may be provided.

The connecting lines 9, which connect the injections unit 7 with the high-pressure lines 4 and 5, respectively are of a double-wall type, as shown in the enlarged sectional circle B in FIG. 1. In particular, the connecting lines 9 each have an inner high-pressure tube 30 and an outer jacket-tube 31. The connecting line 10 may have the same structure.

The connector 11, which is shown only schematically in FIG. 1 will be explained in more detail herein below with reference to FIGS. 2 to 7.

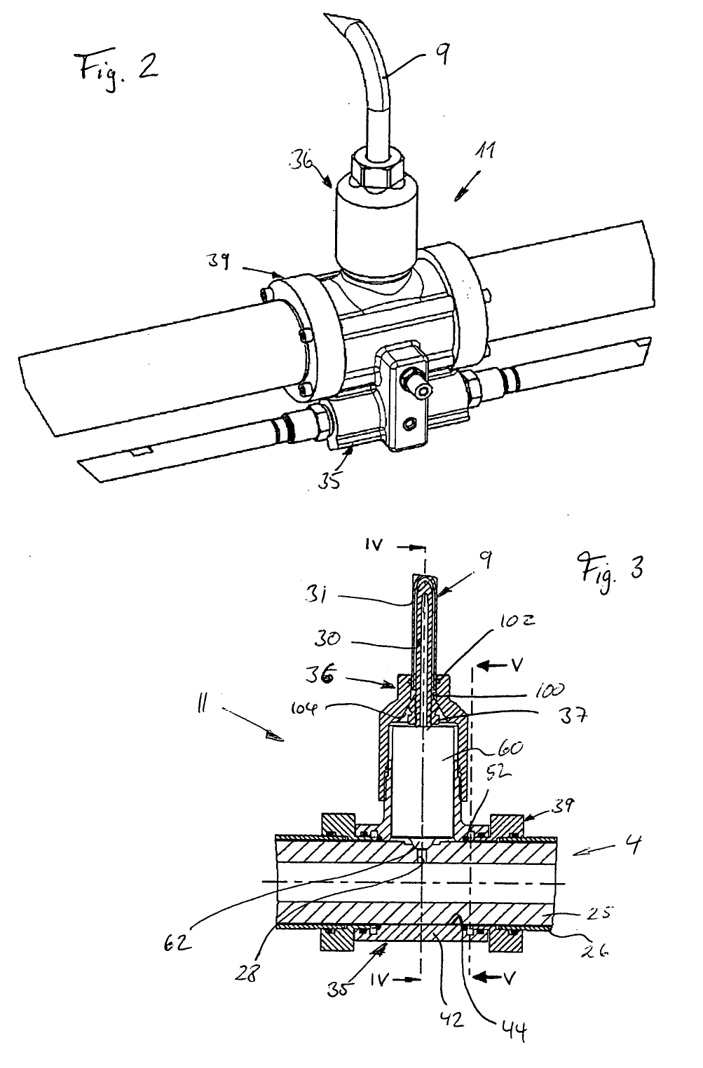

FIGS. 2 to 7 show a first example of a connector 11. The connector 11 has a main body 35, a cap element 36, a clamping piece 37 (see FIG. 3) as well as lateral separating pieces 39.

The main body 35 has a middle part 42 having a circular, cylindrical receiving opening or through-bore 44, a connecting part 46 extending radially with respect to the through-bore 44, as well as a leakage part 48.

The through-bore 44 of the middle part 42 may be stepped, having a middle section of a reduced diameter and adjacent outer sections having a larger diameter. The middle section is sized to receive at least a portion of the high-pressure tube 25 of a high-pressure line 4, 5 in a close fitting manner. Even though the high pressure tube 25 of the high-pressure line 4, 5 is received in the middle section of the through-bore 44 in a tight fitting manner, a gap is formed there between, which allows a flow of fuel therethrough. The outer sections of the circular, cylindrical through-bore 44, which are adjacent to the middle section, are sized to receive a high-pressure tube 25 of the high-pressure line 4, 5 as well as a cylindrical flange 50 of the separating pieces 39. This stepped diameter is best seen in FIGS. 3 and 5. As is also shown in FIGS. 3 and 5, directly adjacent to the step in the circular, cylindrical though-bore 44, a sealing element 52, for example an O-ring, is provided. In the outer sections of the through-bore 44, a leakage groove 54 is formed in a circumferential direction thereof. The sealing element 52 is provided between the leakage groove 54 and the middle section of the through-bore 44. The sealing element seals the middle portion of the through bore 44 towards its free ends with respect to the high pressure line 25. The leakage groove 54 is formed in an area, which normally lies between the sealing element 52 and the free ends on the through bore 44. In the cylindrical flange 50 of the separating pieces 39, radially extending bores 57 are provided in the area of the leakage groove 54. Between the leakage groove 54 and the free ends of the through-bore 44 a ring groove extending in the circumferential direction of the through-bore 44 is provided, for receiving a further sealing element 56 such as an O-ring. The ring groove and the sealing element 56 are arranged such that they seal against an outer circumference of the cylindrical flange 50 of a separating piece 39, as shown in FIGS. 3 and 5.

The connecting part 46 has a passage or through-opening 58 extending radially with respect to the through-bore 44. In the example as shown, the through-opening 58 is sized to receive a flow-limiting valve 60 therein. The flow-limiting valve has at one end a connecting nose 62 fitting to the connecting bore 28 of the high-pressure tube 25. At the opposite end, the flow-limiting valve has a receiving depression for receiving in a sealed manner one end of a high-pressure tube 30 of a connecting line 9, as will be explained in more detail herein below. The flow limiting valve 60 has means for limiting the flow of fluid therethrough in a know manner.

Even though the drawings show a flow-limiting valve 60, this may also be replaced by a simple connecting element having the same dimension but no means for limiting flow of fluid therethrough, or such an element may be completely dispensed with. This is especially considered for the connector 11, connected to the connecting line 10 as in some cases flow-limiting may not be useful at this location. If no connecting element is provided, the through-opening 58 may have smaller dimensions, as it only has to receive the high-pressure tube 30 for connecting the same with the high-pressure tube 25.

The connecting part 46 has a stepped outer circumference, wherein the outer circumference at the free end thereof is smaller than at a proximal portion thereof. An outer thread is formed on the proximal portion, which matches a corresponding inner thread on the cap element 36, as indicated in FIG. 3.

The leakage part 48 associated with the main body 35 has a middle leakage section 70 as well as adjacent outer leakage sections 72. The middle leakage section 70 is aligned in an axial direction of the through-bore 44 with the connecting part 46. The middle leakage section 70 is shown best in the sectional view of FIG. 6.

The middle leakage section 70 is substantially of a cuboid shape and adjoins the middle part 42 of the main body 35. An upper side of the cuboid shaped middle leakage section 70 is arranged on a horizontal central plane C of the circular cylindrical through-bore 44, as shown in FIG. 6. In one embodiment, the middle leakage section 70 has a through-bore 75, which extends horizontally and intersects the through-bore 44 of the middle part 42 below the horizontal central plane C of the through-bore 44. The through-bore 75 has a stepped configuration having a larger diameter at its outer end compared to its inner end adjacent the through-bore 44.

Furthermore, a vertically extending blind bore 77 is provided in the middle leakage section 70, the blind bore 77 intersecting the through-bore 75. Also, a through-bore 79 is provided in the middle leakage section 70, which may extend parallel to the through-bore 44. The through-bore 79 also extends through the outer leakage sections 72, as will be explained in more detail herein below. A horizontally extending connecting bore 80 is provided, which connects the blind bore 77 with the through-bore 79. At the free ends of the blind bore 77 and the connecting bore 80, sealing plugs 81 are received, in order to seal the respective bore 80 towards the environment.

A leakage detection unit 85 is provided outer in the end of the through-bore 75. The leakage detecting unit 85 has a housing 87 having a through-bore 89, in which a piston element 91 is slidably received. At an outer end of the piston element 91 with respect to the leakage section 70, a signal pin 92 is attached.

The housing 87 is secured in the outer end of the through-bore 75, as for example by means of a threaded connection. In a first position the piston element 91 is inserted into the through-bore 75, such that the intersection between the through-bore 75 and the blind bore 77 is blocked, as shown in FIG. 6. In this position, the signal pin 92 is received within the housing 87, as shown in FIG. 6. In a second position (not shown) the piston element 91 is moved within the through-bore 89 of the housing 87 towards the right in FIG. 6, such that the intersection between the through-bore 75 and the blind bore 77 is unblocked. In this position, the signal pin 92 extends from the housing 87, thereby providing an optical indication for the respective position of the piston element. The piston element 91 may be held in the first and second position, respectively, by a predetermined holding force such that it may not move from the respective position without overcoming the holding force.

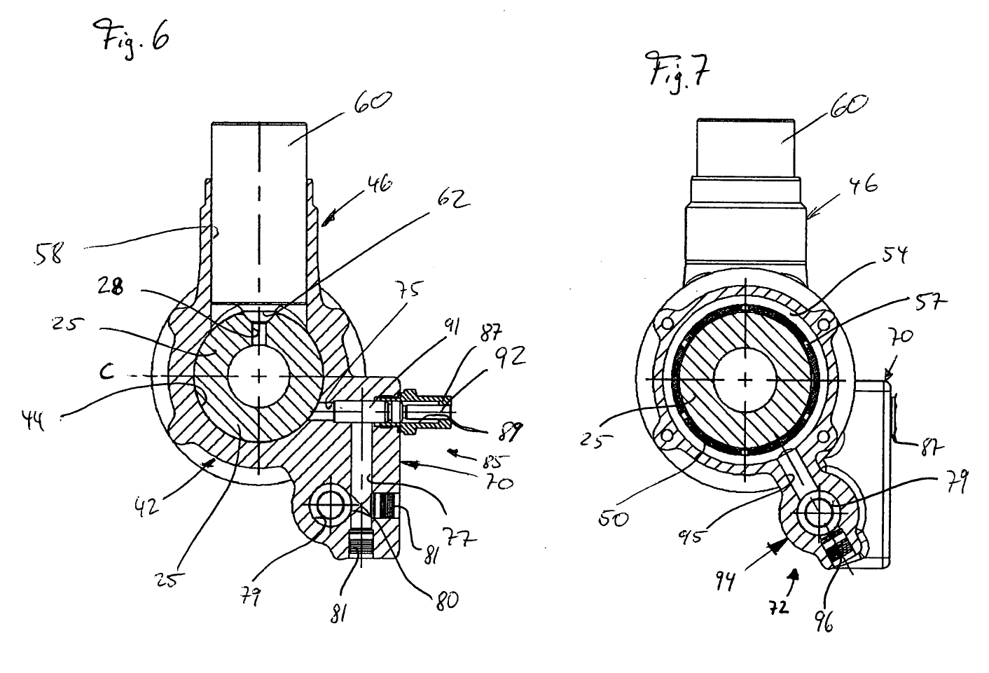

The outer leakage sections 72 each have the same structure, which structure is best shown in the sectional view of FIG. 7. The outer leakage section 72 has a body portion 94 connected to the middle part 42. A through-bore 95 is formed in the body portion 94. The through-bore 95 in each of the outer leakage sections 72 extends radially with respect to the through-bore 44 in the middle part 42 and intersects the same. The through-bore 95 further intersects the through-bore 79 extending through the middle leakage section 70 and the outer leakage sections 72. A free end of the through-bore 95 is sealed by sealing plug 96. The through-bore 95 thus connects the through-bore 44 of the middle part 42 with the through-bore 79 of the detecting part 48. The through-bore 95 intersects the through-bore 44 in the area of the leakage groove 54.

The through-bore 79 is connected to the leakage conduit 20 shown in FIG. 1 and is thus fluidly connected to the leakage fluid collection container 21.

As is best shown in FIG. 3, the cap element 36 has a stepped inner circumference with an inner thread, which may be screwed onto the outer thread of the proximal portion of the connecting part 46. The cap element 36 has a through-bore 100 at its upper end, which is sized to receive part of the connecting line 9. The through-bore 100 is sized to receive the high-pressure tube 30 as well as the jacket tube 31 of the connecting line 9. In the area of the through-bore 100 a sealing element 102, for example an O-ring, is provided, for sealing against the outer circumference of the jacket tube 31 of the high-pressure line 9. Adjacent to the through-bore 100 the cap element 36 has a conical section, which corresponds to a conical section of the clamping piece 37, in order to push the same in the direction of the through-opening 44 of the middle part 42, when the cap element 36 is screwed onto the connecting part 46. The clamping piece 37 has a through-opening for receiving the high-pressure tube 30 of the connecting line 9, in order to press the same into a receiving opening of the flow-limiting valve 60, when the cap element 37 is screwed onto the connecting part 46.

The separating pieces 39 each have, as previously mentioned, a cylindrical flange 50, which is dimensioned to fit into an outer section of the through-bore 44 of the middle part 42 of the main body 35. The separating pieces 39 each have a stepped through-bore, wherein the cylindrical flange 50 defines a first inner diameter and a main body of the separating piece 39 defines a second inner diameter. The first inner diameter is smaller than the second inner diameter and is dimensioned to receive a high pressure tube 25 of a high-pressure line 4,5, but not a jacket tube 26. The second inner diameter is dimensioned to receive a jacket tube 26 of a high-pressure line 4, 5 therein. In the area of the main body a receiving groove for receiving a sealing element 106 is provided for sealing against an outer circumference of the jacket tube 26.

Each separating piece 39 is arranged to hold a jacket tube 26 of a high-pressure line 4,5 with respect to a connector 11. In particular, a space formed between the high-pressure tube 25 and the jacket tube 26 of a high-pressure line 4, 5 is fluidly connected to the leakage groove 54 of the through-bore 44 via the separating piece 39. At the same time, this space is sealed with respect to the environment. Thus, a space formed between the high-pressure tube 25 and a jacket-tube 26 of a high-pressure line 4, 5 is connected via the separating piece 39, the leakage groove 54 in the through-bore 44 and the through-bore 95 in an outer leakage section 72 to the through-bore 79. In a corresponding manner, a space between the high-pressure tube 30 and the jacket tube 31 of a connecting line 9 is fluidly connected via the cap element 36, the connecting part 46 and the cylindrical through-bore 44 to the though-bore 75. If the piston element 91 of the leakage detection unit 85 is in the first position, a fluid connection to the blind bore 77 is blocked. If the piston element 91 is in a second position, a fluid connection is also provided to the through-bore 79 via the blind bore 77.

The space between the high-pressure tube 25 and the jacket tube 26 of the high-pressure line 4, 5 on the one hand, and the high-pressure tube 30 and the jacket tube 31 of the connecting line 9 on the other hand, are sealed against each other by at least the sealing element 52.

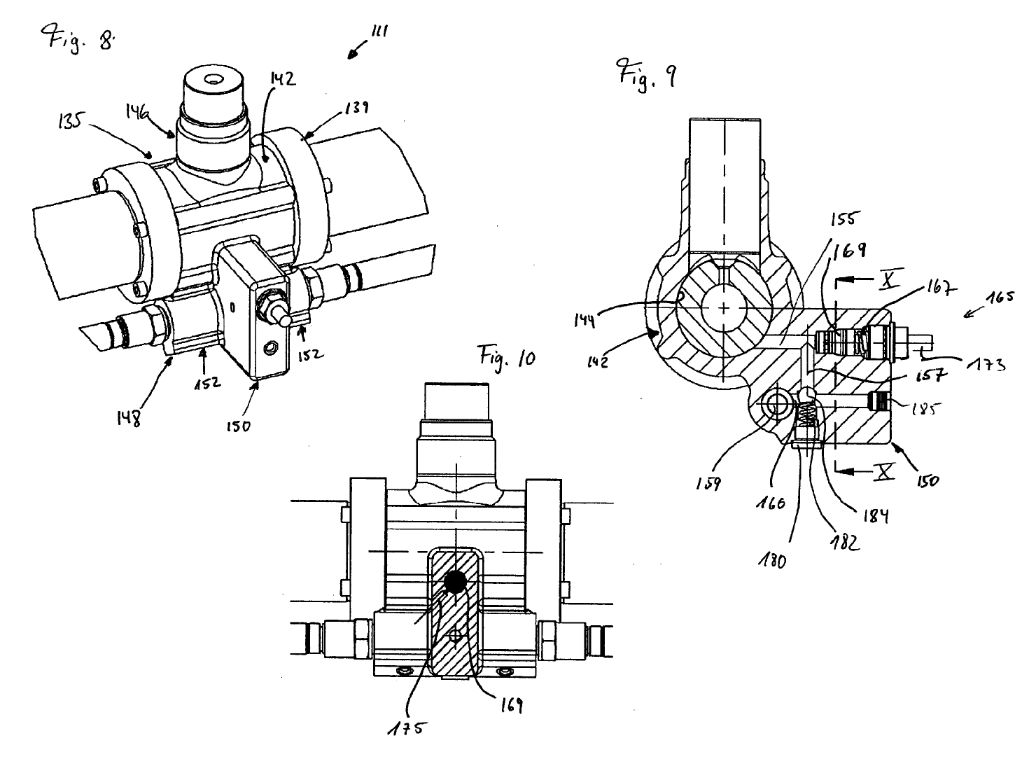

With respect to FIGS. 8 to 10, an alternative example of a connector 111 is described which may be used in the fuel system 1 of FIG. 1. The connector 111 features, like the connector 11 according to FIGS. 2 to 7, a main body 135, a cap element (not shown), corresponding to the cap element 36, a clamping piece (not shown), corresponding to clamping piece 37, as well as separating pieces 139. The main body 135 of connector 111 further features a middle part 142 having a through-bore 144, a connecting part 146 as well as a leakage part 148. The middle part 142 and the connecting part 146 are similar to the previously described middle part 42 and connecting part 46 described with respect to FIGS. 2 to 7. Thus, reference is made to the previous description, in order to avoid undue repetitions.

The leakage part 148, however, differs from the previously described leakage part 48. The leakage part 148 has a middle leakage section 150, as well as adjacent thereto outer leakage sections 152. The outer leakage sections 152 have the same structure as the outer leakage sections 72 described with respect to the previous example, and therefore, reference is made to the previous description.

The middle leakage section 150 again features a cuboid housing portion, adjoined to the middle section 142 of connector 111, as is best shown in FIGS. 8 and 9. As shown in FIG. 9, the middle leakage section 150 features a horizontally extending through-bore 155, which intersects the through-bore 144 in the middle section 142. Further, a vertically extending blind bore 157 is provided, which intersects the through-bore 155. Furthermore, a through-bore 159, corresponding to through-bore 79 according to the previous example, is provided. A connecting bore 160 is provided, which connects the vertical blind bore 157 with the through-bore 159. The through-bore 155 has a stepped inner diameter having a larger diameter in a portion extending between the intersection of the through-bore 155 with the blind bore 157 and an outer end thereof, as may be seen in FIG. 9. In this portion, a leakage detecting unit 165 is provided. The leakage detecting unit 165 features a housing 167, a sealing element 169, a biasing spring 171 as well as a pull pin 173.

The housing 167 is mounted into the outer end of through-bore 155, for example by a threaded connection. The sealing element 169 is received in a stepped portion of the through-bore 155 and is guided via the pull pin 173 within the housing 167 in a longitudinal direction of the through bore 155.

The biasing spring 171 is provided between the sealing element 169 and the housing 167 and biases the sealing element 169 in a position for a sealing engagement with through-bore 155, as shown in FIG. 9.

The pull pin 173 extends out of the housing 167 and may be grasped from the outside. The pull pin 173 is connected to the sealing element 169 and via the pull pin 173 the sealing element 169 may be moved against the bias of the biasing spring 171.

The middle leakage section 150 further features a leakage check bore 175 extending between the through-bore 155 and an outside of the cuboid housing portion. The leakage check bore 175 intersects the through-bore 155 in an area, which is typically sealed by the sealing element 169 towards an inner area of the through-bore 155. If the sealing element 169, however, is pulled via the pull pin 173 towards the right according to FIG. 9, the leakage check bore 175 is open towards the inner portion of the through-bore 155. Therefore, fluid, which is present in the inner portion of the through-bore 155, may flow towards the leakage check bore 175 and to the outside.

The free end of the blind bore 157 is closed by a sealing plug 180. The sealing plug 180 supports a biasing spring 182, which supports at its free end a sealing element 184 in the shape of a ball. The sealing element 184 is biased via the biasing spring 182 against a sealing seat, formed in the area of the intersection between the blind bore 157 and the connecting bore 160. The sealing element 184 thus seals an upper portion of the blind bore 157 towards the connecting bore 160 and thus towards the through-bore 159. The free end of the connecting bore 160 is closed by a corresponding sealing plug 185.

The biasing spring 182 provides a predetermined force to hold the sealing element 184 in sealing engagement with the sealing seat. The predetermined force is chosen such that it may be overcome by leakage fluid which is accumulating within the upper portion of the blind bore 157 and the through-bore 155 (and possibly within the middle section 142 of connector 111. The biasing force of the biasing spring 182 is chosen such that the leakage fluid has to accumulate to a level, at which the through-bore 155 is at last partially filled. While the sealing element 184 is in its sealing engagement, it also blocks a reverse flow of fluid from the through-bore 159 towards the upper portion of the blind bore 157.

Another example of a connector 211 will be described with respect to FIGS. 11 to 13 herein below, which connector 211 may be used instead of connector 11 in FIG. 1.

Connector 211 features, like connector 11 according to FIGS. 2 to 7, a main body 235, a cap element (not shown), corresponding to cap element 36, a clamping piece (not shown), corresponding to clamping piece 37, as well as separating pieces 239. The main body 235 of connector 211 has a middle part 247 having a through-bore 244, a connecting part 246 as well as a leakage part 248. The middle part 242 having the through-bore 244 and the connecting part 246 are similar to the previously described middle part 42 having the through-bore 44 and connecting part 46. Therefore, reference is made to the previous description, in order to avoid repetition.

The leakage part 248, however, differs from the previously described leakage part 48. The leakage part 248 has a middle leakage section 250, as well as adjacent thereto outer leakage sections 252. The outer leakage sections 252 have the same structure as the outer leakage sections 72 previously described, and thus reference is made to the previous description.

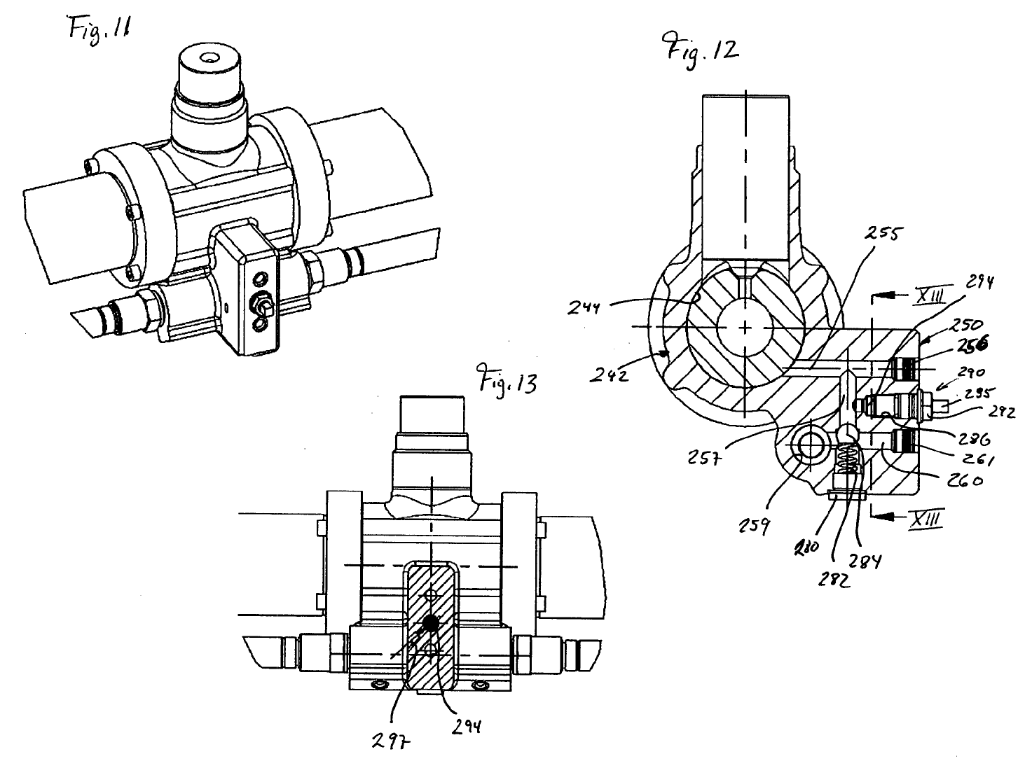

The middle leakage section 250 again has a cuboid housing portion, adjoined to the middle part 242 of connector 211, as best seen in FIGS. 12 and 13. As shown in FIG. 12, the middle leakage section 250 features a horizontally extending through-bore 255, which intersects the through-bore 244 in the middle part 242. A free end of the through-bore 255 is closed by a sealing plug. A vertically extending blind bore 257 is provided which intersects the through-bore 255. The middle leakage section 250 also has a through-bore 259 corresponding to through-bore 79 according to the previous examples. Furthermore, a connecting bore 260 is provided, which connects the vertical blind bore 257 with the through-bore 259.

The free end of the blind bore 257 is sealed by a sealing plug 280. The sealing plug 280 supports a biasing spring 282, which at its free end carries a sealing element 284 in the shape of a ball. The sealing element 284 is biased by the biasing spring 282 against a corresponding sealing seat, which is formed at the intersection between the blind bore 257 and the connecting bore 260. The sealing element 284 thus seals an upper portion of the blind bore 257 with respect to the connecting bore 260 and thus with respect to the through-bore 259. The free end of the connecting bore 260 is sealed by a corresponding sealing plug 261.

A further blind bore 286 is provided in the middle leakage section 250, which intersects the vertically extending blind bore 257 at an elevation which lies between the through-bore 255 and the connecting bore 260. The blind bore 286 is a stepped bore, in which a leakage detecting unit 290 is provided. The leakage detecting unit 290 may be of the same type as the leakage detecting unit 265 according to the previous example. In the example shown in the drawings, however, the leakage detection unit 290 features a housing 292, which is mounted into the outer end of the blind bore 286 and seals the same. A sealing element 294 is received within the housing, which is connected to a screw extension 295. The screw extension 295 and/or the sealing element 294 include an outer thread, which is in engagement with an inner thread formed within the housing 292. The engaging threads allow setting the axial position of the sealing elements 294 with respect to the housing 292 and thus with respect to the blind bore 286 by rotation of the screw extension 295. In a first position, as shown in FIG. 12, the sealing element 294 seals the blind bore 286 with respect to the blind bore 257.

Furthermore, a leakage check bore 297 is provided in the middle leakage section 250 extending between the blind bore 286 and the outside of cuboid housing portion. The leakage check bore intersects the blind bore 286 in an area, which is normally sealed by the sealing element 294. When the sealing element 294 is axially displaced within the blind bore 286 by rotation of the screw extension 295, the leakage check bore 297 may be opened.

The biasing spring 282 exerts a predetermined bias force to hold the sealing element 284 in sealing engagement. The predetermined force is chosen such that leakage fluid accumulating in the blind bore 257 (and maybe the through-bore 255) may overcome this force, in order to drain the leakage fluid. The biasing force of the biasing spring 282 is of a magnitude that the leakage fluid has to accumulate at least up to a lower rim of the blind bore 286 before the biasing force may be overcome.

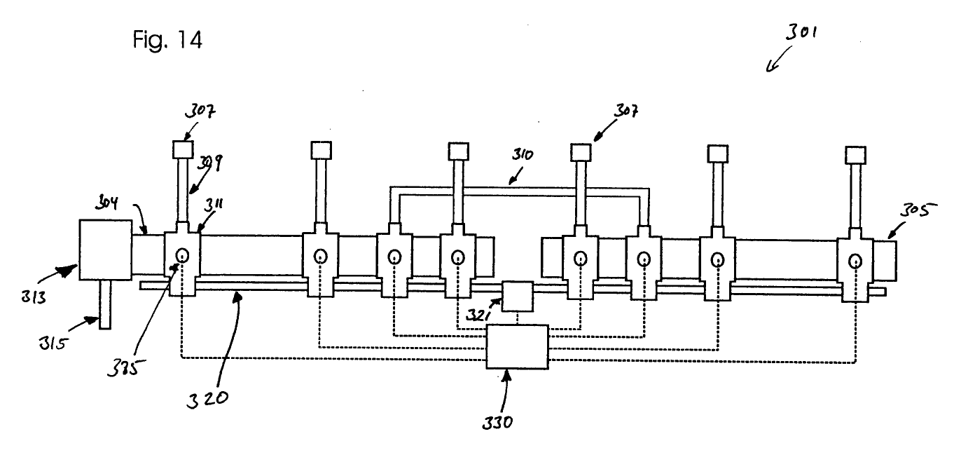

FIG. 14 shows a schematic representation of an alternative fuel system 301 for a combustion engine (not shown). The fuel system 301 has two high-pressure lines 304, 305, which are typically denoted as Common Rails. Furthermore, the fuel systems 301 has a plurality of injection units 307, which are each connected to high-pressure lines 4 and 5, respectively, via a connecting line 309 and a connector 311. The high-pressure lines 4 and 5 are fluidly connected to each other via connecting line 310 and corresponding connectors 311.

The fuel system 301 further has a connector 313, which is connected to high-pressure line 304. The connector 313 is connected via at least one connecting line 315 with a source of highly pressurized fuel, such as a fuel pump. Even though FIG. 14 only shows one connector 313 and one connecting line 315 connected to high-pressure line 304, a corresponding connector 313 could also be provided at high-pressure line 305, in order to separately supply high-pressure line 305 with highly pressurized fuel. The connecting line 310 could still be provided in order to balance pressure fluctuations between the respective high-pressure lines 304 and 305.

The fuel system 301 also has a leakage conduit 320 for receiving leaking fuel and a leakage fluid collection container 321.

The high-pressure lines 304 and 305 are each of a double-wall structure like the high-pressure lines 4 and 5 of fuel system 1 according to FIG. 1. The same is true for the connecting lines 309 and 310 which are both of a double-wall structure like the corresponding connecting lines in fuel system 1 described with respect to FIG. 1. In this respect fuel systems 1 and 301 are of the same structure.

Additionally, fuel system 301, however, features a control unit 330, which is connected to a sensor (not shown) in the leakage fluid collection container 321 and sensors at the respective leakage detection unit at the connectors 311.

The connectors 311 are for example of the type shown in FIGS. 2 to 7. Additionally to the elements shown in FIGS. 2 to 7, however, the leakage detection unit 85 according to the example of FIG. 14 has a sensor element, which automatically senses the position of the piston element 91 and/or the signal pin 92 and generates a corresponding positional signal for the control unit 330. In addition to the optical indication by a protruding pin 92, an electronic signal may be provided for the control unit 330, in case a leakage occurs in an area associated with the middle leakage section. In the same manner, the sensor element (not shown) in the leakage fluid collection container 321 is capable of automatically detecting leakage fluid therein and to provide a leakage signal for the control unit 330.

A similar sensor could also be provided in the examples according to FIGS. 8 to 13, wherein for example the position of a ball 184 or a ball 284 may be detected. If ball 184 or ball 284 is lifted off the sealing seat, again an electrical signal may be generated and provided to the control unit 330. The corresponding detecting units which have to be operated manually may be dispensed with in this case or they can still be present to allow manual checking of a leakage. Also, other sensors may be provided in a connector 311, which allow automatic detection and generation of an electrical signal.

### INDUSTRIAL APPLICABILITY

Operation of the fuel system 1 will be explained with respect to FIGS. 1 to 7 herein below. During operation of the fuel system 1, highly pressurized fuel is introduced into the high-pressure tube 25 of the high-pressure line 4 via the connecting line 15 and the connector 13 in any suitable manner. The highly pressurized fuel is supplied to the high-pressure tube 25 of the high-pressure line 5, via the connecting line 10, which extends between two connectors 11.

The highly pressurized fuel is supplied via the respective connectors 11, having the flow limiting valves 60 received therein, and the connecting lines 9 to the corresponding injection units 7, for injecting fuel in corresponding cylinders of a combustion engine (not shown) in a known manner. This represents normal operation of the fuel system.

If, however, a leakage of the highly pressurized fuel occurs, such leakage may be detected as follows. First, we distinguish between different areas of leakage, which may be separately detected. These areas include, but are not limited to:

A first leakage area (area 1) is located within the jacket tubes 26. A leakage in this area may occur due for example a crack, in particular a hairline crack in the high-pressure tube 25 of one of the high-pressure lines 4, 5.

A second leakage area (area 2) is associated with each connector 11 connected to a connecting line 9 and also includes the area of the respective connecting line 9. A leakage may occur in particular in the area of the connection between the flow limiting valve 60 and the high-pressure tube 25, between the high-pressure tube 30 and the flow limiting valve 60, and between the high-pressure tube 30 and the corresponding injection unit 7.

Further leakage may occur due to a crack in a high-pressure tube 30 of connecting line 9 or due to breakage thereof. Furthermore, leakage may also occur due to a crack in the high-pressure tube 25, which crack opens towards the through-bore 44 in an area fluidly connected to a respective middle section 70 of a leakage part 48.

A third leakage area (area 3) is associated with each connector 11 connected to the connecting line 10 and also encompasses the connecting line 10 itself. A leakage may in particular occur due to a leakage of the corresponding high-pressure tube of the connecting line 10 or due to leakage in the connecting areas of the high-pressure tubes to the respective high-pressure lines 4, 5. Also, leakage may occur due to a leakage of the high-pressure tube 25, which is open towards a section of the through-bore 44 of the connector 11, which is fluidly connected to a respective middle section 70 of a leakage part 48. Furthermore, we distinguish between two different types of leakage. A first type of leakage occurs due to a leakage of the high-pressure tube 25 of one of the high-pressure lines 4, 5. All other leakages are classified as a second type of leakage.

When a leakage of the first type occurs, i.e. a leakage in the high-pressure tube 25 of one of the high-pressure lines 4, 5 it depends on whether this leakage occurs in a section of the through-bore 44 of one of the connectors 11 fluidly connected to the middle leakage section 70 thereof (area 2 or 3) or outside thereof (area 1). If the leakage occurs in area 2 or 3, leaking fuel exits the high-pressure tube 25 into the space formed between the through-bore 44 and the high-pressure tube 25. The fuel then flows into the through-bore 75, as best shown in FIG. 6. After reaching a predetermined amount, the fuel pushes the piston element 91 to the right according to FIG. 6. The signal pin 92 is thus pushed out of the housing 89, providing an optical indication for a leakage in this area The leaking fuel then flows via the blind bore 77 and the connecting bore 80 into the through-bore 79, which is connected to the leakage conduit 20. The fuel then flows within the leakage conduit 20 to the leakage fluid collection container 21, in which a sensor is provided, which upon detecting the fuel issues a corresponding signal, such as a visual and/or audio warning.

If leakage of the high-pressure tube 25 occurs in area 1, then the fuel leaks into a space between high-pressure tube 25 and jacket tube 26 of a high pressure line 4, 5 or the corresponding space between high-pressure tube 25 and a separating piece 39, if leakage occurs at such location. The fuel then flows via the leakage groove 54 of through-bore 44 into the through-bore 95 of the outer leakage section 72 and into the through-bore 79 of an adjacent connector 11. The fuel then flows via the leakage conduit 20 to the leakage fluid collection container 21, where a corresponding detection is performed and a signal is provided.

If a leakage of the second type occurs, for example in the area of connecting line 9 (area 2), leaking fuel for example flows into the space formed between high-pressure tube 30 and jacket tube 31. This occurs if the leakage occurs in the connecting area towards the injection unit 7 or if leakage occurs due to a crack in the high-pressure tube 30 in an area which is surrounded by the jacket tube 31. The fuel then flows via the cap element 36 to the connecting piece 46 and through a space defined between the flow limiting valve 60 and the through-bore 58 of the connecting part 46 towards the through-bore 44. From there the fuel flows between the inner circumference of the through-bore 44 and the outer circumference of the high-pressure tube 25 and fills this space until the fluid level reaches the through-bore 75 of the middle leakage section 70. After reaching a predetermined fluid level, the piston element 91 is again pushed toward the right (according to FIG. 6) and a fluid connection towards the blind bore 77 is opened. The signal pin 92 is again pushed out of the housing 89 and thus provides an optical indication for a leakage in this area. The fuel then flows via the blind bore 77 and the connecting bore 80 into the through-bore 79. From the through-bore 79 the fuel then flows via the leakage conduit 20 to the leakage fluid collection container 21, where the fuel is again detected.

If leakage occurs in the connecting area between the high-pressure tube 30 of the connecting line 9 with the flow limiting valve 60 or the connecting area between the flow limiting valve 60 and the high-pressure tube 25 of a high-pressure line 4 or 5, the fuel again flows into the space between the inner circumference of the through-bore 44 and the outer circumference of the high-pressure tube 25. The fuel then flows in the above described manner towards the leakage fluid collection container 21.

If a leakage occurs in the area of the connecting line 10 or in the connecting areas thereof to the high-pressure tube 25 of the high-pressure lines 4 or 5 (area 3) fuel again flows via a middle leakage section 70 of a connector 11, as described above.

An operator, after receiving a warning signal given out by a sensor in the leakage fluid collection container 21, may now narrow down the local occurrence of the leakage. If none of the signal pins 92 at the connectors 11 is visible by protruding from a corresponding housing, then a leakage of the first type is present in the area 1. The operator may then initiate appropriate measures for repairing the leakage.

If one of the signal pins 92 of a connector 11, which is connected to one of the connecting lines 9 is visible, then the operator knows that a leakage of the first or second type is present in this area and can initiate appropriate measures. Thus, the engine may be operating until repair of the leakage is possible.

In a corresponding manner, the operator can determine by the position of the signal pins 92 of the connectors 11 which are associated with connecting line 10, whether a leakage has occurred in this area, and may initiate appropriate measures.

The fuel system described above, thus enables identifying the location of a leakage and may also give an indication with respect to the type of leakage.

Operation of a fuel system 1 as shown in FIG. 1, having a connector 111 according to FIGS. 8 to 10 will be described herein below.

Operation of the fuel system 1 is substantially the same as operation of the previously described fuel system. A difference, however, lies in detecting a leakage, which is associated with leakage areas 2 and 3 as defined above, which are associated with a middle leakage section 150 of connector 111.

If leakage occurs in these areas, fuel flows into a space between a high-pressure tube and the through-bore 144 of the middle section 142 of connector 111. From there the fuel flows into the through-bore 155 and unimpeded into the blind bore 157. Above the intersection between the blind bore 157 and the connecting bore 160 the fuel is accumulating due to the sealing engagement between the sealing element 184 and the corresponding sealing seat provided in the blind bore 157. The fuel is accumulated until the force exerted by fuel onto the sealing element 184 overcomes the biasing force of the spring 182, such that the sealing element 184 is moved away from said sealing seat. At this point in time the fuel flows into the connecting bore 160 and from there to the through-bore 159. The fuel then flows via a corresponding leakage conduit 20, as shown in FIG. 1, towards the leakage fluid collection container 21, where leakage detection, as described above, is performed.

If the force applied to the sealing element 184 decreases due to discharge of fuel, the sealing element 184 is again brought into sealing engagement with the sealing seat and the fuel again accumulates. The force of the spring 182 is chosen such that the fuel accumulates until it at least partially fills the through-bore 155.

If detection of leaking fuel has occurred in the leakage fluid collection container 21 and a corresponding warning has been given, an operator may now check the respective connectors 111 to see whether a leakage has occurred in their vicinity. The operator pulls the pull pin 173, in order to move the sealing element 169 from its sealing position in the through-bore 155. Thereby, the leakage check bore 175 is opened with respect to the through-bore 155. Since fuel, if a leakage in the vicinity of the connector 111 is present, has accumulated to at least partially fill the through-bore 155, the fuel would now excit through the leakage check bore 175, thus giving the operator a visual indication that leakage has occurred in this area.

The operator can perform corresponding checking operations at all connectors 111, in order to enable localization of the leakage and in some cases to provide information with respect to the type of leakage, as described above.

Operation of the fuel system 1 according to FIG. 1, having a connector 211 according to FIGS. 11 to 13 will be described herein below.

Operation is substantially the same as operation described with respect to connector 111 of the previous example. In contrast to the local leakage check operation at the middle leakage section 150, rather than pulling the pull pin 173, the screw extension 295 is rotated in order to open the leakage check bore 297, to allow checking whether leakage has occurred at each connector 211. An operator is thus again put into a position to locally check leakage as was the case in the previous examples. The main difference compared to the previous example is in how the leakage detection unit 290 is operated and its location within a connector. The location within the connector may be advantageous inasmuch as less accumulation of leakage fluid is necessary compared to the examples shown in FIGS. 8 to 10.

It is to be noted, that the leakage detection unit 165 may also be used in the example of FIGS. 11 to 13, and also, the leakage detection 290 may be used in the example shown in FIGS. 8 to 10.

Operation of the fuel system 301 shown in FIG. 14 is substantially the same as operation of the fuel system 1. The additional sensors, however allow automatic generation of leakage signals, if for example leakage occurs at one of the connectors 311 or 313. During operation of the fuel system 301, the control unit 330 may thus automatically detect leakage within the fuel system 301. Furthermore, the control unit 330 is capable of detecting the local area of the leakage and in some cases also the type of leakage. If a leakage is indicated at a leakage detection unit on one of the connectors 311 the control unit 330 may in some cases also determine the amount of leakage. This may be determined on the basis of a time delay between receipt of a leakage signal from a leakage detection unit at one of the connectors 311 and the receipt of a leakage signal by the sensor element in the leakage fluid collection container 321. The shorter the time difference between the receipt of the signals, the larger the leakage, since as fuel will flow faster through the leakage conduit 20 to the leakage fluid collection container 321 and will thus be detected faster thereat, if the amount of leaking fuel is larger. The time differences also differ due to the respective position of the connectors with respect to the leakage fluid collection container 320.

On the basis of the data received by the control unit 330, the control unit may now automatically control operation of the engine. As an example, the control unit 330 may no longer energize individual ones of the injection units 307, in order to block injection thereby. In so doing, further leakage in this area may be prohibited or at least reduced, while operation of the engine may be continued.

Even though the representation according to FIG. 14 shows signal lines connecting the control unit 330 with the corresponding leakage detection units at the connectors 311, it is also possible to dispense with such signal lines and to provide manual input of the data into the control unit 330 by an operator. For example, an operator may manually check whether leakage has occurred at each of the connectors 311, after detection of leakage in the leakage fluid collection container 321. Thereafter, the operator may input the thus determined data into control unit 330, which may control operation of the engine and the fuel system 301 on the basis of these data.

The above disclosure relates to specific examples without being limited to these specific samples. In particular, it is not necessary, that the respective leakage parts are integrally formed with the main body of the respective connector. It is also possible that the leakage parts are connected via separate conduits, which are for example extending between a middle part of the connector and a leakage part thereof. Such leakage parts could again have local leakage detection units and may be connected to a common leakage conduit. Further, it is also possible to provide for a local leakage detection at each of the through-bores provided in the outer leakage sections. A leakage detection unit such as the leakage detection unit 85 according to FIG. 6 may for example be provided within each of the corresponding through-bores. These could again be provided with a sensor, for automatically sensing a position of the sealing element and to provide a signal to a control unit 330 as shown in FIG. 14. Also, a check valve having automatic position detection could be used. Due to a time delay between receipt of a signal of such a detection unit and the detection unit in the leakage fluid collection container, the amount of leakage may be determined. Rather than providing a separate leakage fluid collection container, it is also possible to guide the leaking fluid to the fuel tank and to provide for a leakage detection at the respective conduit.

It is noted that the features of the previously described samples may be freely combined and exchanged whether such a combination or exchange is compatible with the specific examples.

1. A Connector for connecting a double-wall tubing to a high-pressure line, said connector comprising:
a main body having:
a receiving opening for receiving at least a portion of the high-pressure line,
a first passage, which is open to said receiving opening for connecting at least a portion of said double-wall tubing to said high-pressure line, and
a second passage, which is open towards said receiving opening; and
means for detecting a fluid in the second passage.

2. The connector according to claim 1, said connector having at least one seal arrangement for sealing a space between the main body and the high-pressure line, when it is received in the receiving opening.

3. The connector according to claim 1, wherein the receiving opening is a through-opening for passing the high-pressure line therethrough.

4. (canceled)

5. The connector according to claim 1, wherein the first and second passages are aligned in a longitudinal direction of said receiving opening.

6. (canceled)

7. (canceled)

8. The connector according to claim 1, wherein the first passage extends radially with respect to the receiving opening.

9. The connector according to claim 1, wherein the second passage intersects the receiving opening below a horizontal central plane thereof.

10. The connector according to claim 1, wherein the means for detecting a fluid in the second passage comprises an automatic fluid sensor capable of outputting an electrical signal.

11. The connector according to claim 1, wherein the means for detecting a fluid in the second passage comprise at least one movable element, which in a first position blocks said second passage and in a second position at least partially opens said second passage.

12. (canceled)

13. (canceled)

14. (canceled)

15. (canceled)

16. (canceled)

17. (canceled)

18. (canceled)

19. (canceled)

20. (canceled)

21. (canceled)

22. The connector according to claim 1, wherein said connector has at least one third passage which is open towards said receiving opening.

23. (canceled)

24. The connector according to claim 22, wherein the third passage is offset with respect to the first and second passages in a longitudinal direction of said receiving opening.

25. The connector according to claim 22, said connector having at least one seal arrangement for generating separate spaces between the main body and the high-pressure line, when it is received in the receiving opening, wherein said at least one sealing arrangement is arranged in a longitudinal direction of said receiving opening between said third passage and said first and second passages.

26. The connector according to claim 22, wherein the second and the third passages are open towards a common fourth passage, which is configured for connection to a drain conduit.

27. (canceled)

28. (canceled)

29. (canceled)

30. A connector for connecting at least a portion of a double-wall tubing having an inner tube and an outer tube to a high-pressure line, said connector comprising a main body defining
a connecting opening for establishing a fluid connection between the inner tube and the high pressure line
a fluid detection passage, and
a fluid connection between said outer tube and said fluid detection passage.

31. The connector according to claim 30, wherein said fluid connection between said outer tube and said fluid detection passage is defined outside said high pressure line.

32. The connector according to claim 30, wherein said main body defines a receiving opening for receiving a coupling portion of said high pressure line and said fluid connection between said outer tube and said fluid detection passage is at least partially formed by said receiving opening.

33. The connector according to claim 30, said connector comprising means for detecting a fluid in the fluid detecting passage.

34. A fuel system for an engine, said fuel system comprising:
a high-pressure line, having a coupling opening;
a double-wall tubing having an inner tube and an outer tube;
a connector coupling said inner tube of the double wall tubing to the coupling opening of the high pressure line and providing a fluid connection between the outer tube of the double wall tubing and a fluid detection passage of the connector; and
means for detecting fluid in said fluid detecting passage.

35. The fuel system according to claim 34, wherein said means for detecting fluid in said fluid detecting passage are attached to said connector.

36. The fuel system according to claim 34, wherein said means for detecting fluid in said fluid detecting passage are configured to provide automatic detection of fluid and for providing an indication when fluid is detected.

37. The fuel system according to claim 34, wherein said high pressure line has a plurality of coupling openings, said fuel system further having
a plurality of double wall tubings,
a corresponding plurality of connectors, each connector coupling an inner tube of a corresponding double wall tubing to a corresponding coupling opening of the high pressure line and providing a fluid connection between a corresponding outer tube of the double wall tubing and a corresponding fluid detection passage of the connector, and
a corresponding plurality of separate means for detecting fluid in a corresponding fluid detection passage.

38. The fuel system according to claim 37, wherein at least two of said fluid detecting passages are connected to a common conduit and wherein means for detecting fluid in said common conduit are provided, said means for detecting fluid in said common conduit being separate from said means for detecting fluid in a fluid detection passage.

39. The fuel system according to claim 38, wherein at least one of said means for detecting fluid in said common conduit and said means for detecting fluid in a fluid detection passage are configured to provide automatic detection of fluid and to provide an indication if a fluid is detected.

40. (canceled)

41. (canceled)

42. (canceled)

43. (canceled)

44. (canceled)

45. (canceled)

46. (canceled)

47. (canceled)

48. A method for detecting a leakage in a fuel system having
a high pressure line having a plurality of first sections each surrounded by a respective jacket tube and a plurality of second sections each surrounded by a respective connector, said second sections each having a coupling opening, and
a plurality of double wall tubings each having an inner tube and an outer tube, wherein the respective elements are arranged such that a plurality of first spaces is formed between the respective jacket tubes and said high pressure line and a plurality of second spaces is formed between the respective connectors and said high pressure line, wherein said first and second spaces are sealed from each other and wherein said outer tubes are fluidly connected to said second spaces, said method comprising:
conducting leakage fluid from at least one of said second spaces to an associated one of a plurality of first fluid detection units and subsequently to a second fluid detection unit;
conducting leakage fluid from said first space to a said second fluid detection unit; and
detecting the presence of leakage fluid at at least one of said first and second detection units.

49. The method of claim 48, wherein said method provides for automatic detection of fluid at at least one of the second detection unit and the first detection units; and outputting of a corresponding signal.

50. (canceled)

51. (canceled)

52. (canceled)

53. (canceled)

54. The method of any one of claims 48, wherein said signal is issued to a control unit, which determines at least one of the location of the leakage and the type of leakage on the basis of which of the detection units has indicated a leakage.

55. (canceled)

56. The method of claim 54, wherein said control unit determines the magnitude of the leakage on the basis of a time delay between receipt of a signal from a first detection unit and receipt of the signal from the second detection unit.

57. (canceled)

58. (canceled)

59. (canceled)

60. (canceled)
